(19) United States
(12) Patent Application Publication
(10) Pub. No.: US 2014/0360874 A1
(43) Pub. Date: Dec. 11, 2014

(54) LIQUID RESIDUE DETECTION DEVICE

(71) Applicant: DENSO CORPORATION, Kariya-city (JP)

(72) Inventor: Kenji Yamamoto, Chita-gun (JP)

(21) Appl. No.: 14/300,519

(22) Filed: Jun. 10, 2014

(30) Foreign Application Priority Data
Jun. 10, 2013 (JP) 2013-121998

(51) Int. Cl. G01N 27/416

(52) U.S. Cl. CPC G01N 27/4166
USPC 204/406

(57) ABSTRACT

A liquid residue detection device detecting a residue of a liquid stored in a container is provided. The liquid residue detection device includes (i) a first electrode and a second electrode placed into the container so that areas that each of the first electrode and the second electrode contacts with the liquid decrease as a liquid level of the liquid stored in the container is low, (ii) an AC signal generation portion generating an AC signal applied to the first electrode, and (iii) a detector circuit detecting the AC signal inputted from the second electrode and outputting voltage that changes continuously according to a residue of the liquid stored in the container.

### CROSS REFERENCE TO RELATED APPLICATION

This application is based on Japanese Patent Application No. 2013-121998 filed on Jun. 10, 2013, the disclosure of which is incorporated herein by reference.

### TECHNICAL FIELD

The present disclosure relates to a liquid residue detection device to detect a residue of a liquid stored in a container.

### BACKGROUND OF THE INVENTION

PATENT DOCUMENT 1: JP-A-H9-26350

Conventionally, there is a device to have multiple electrodes with different length, the multiple electrodes which detect a change of a liquid level, and to output an alarm signal indicating the change of a liquid level based on a conductive state between the multiple electrodes (for example, referring to patent document 1).

The inventors of the present disclosure have found the followings. The device described in the patent documents 1 has multiple electrodes of different length, and outputs an alarm signal indicating a change of the liquid level based on the conductive state of the multiple electrodes. Since the device described in the patent document 1 does not detect the change of the liquid level continuously, a residue of a liquid may be undetectable precisely.

In addition, since the device described in patent document 1 applies a DC voltage between electrodes, for example, when a change of a liquid level of a washing liquid for washing a window of a vehicle is detected, a relatively large amount of a viscous material may be deposited by an electrolysis and the viscous material adheres to the electrodes.

### SUMMARY

It is an object of the present disclosure to provide a liquid residue detection device detecting a residue of a liquid continuously, controlling deposition of a viscous material or the like.

According to one embodiment of the present disclosure, a liquid residue detection device detecting a residue of a liquid is provided. The liquid residue detection device includes (i) a first electrode and a second electrode placed into the container so that areas that each of the first electrode and the second electrode contacts with the liquid decrease as a liquid level of the liquid stored in the container is low, (ii) an AC signal generation portion generating an AC signal applied to the first electrode, and (iii) a detector circuit detecting the AC signal inputted from the second electrode and outputting voltage that changes continuously according to a residue of the liquid stored in the container.

According to the liquid residue detection device, a first electrode and a second electrode are placed so that a contact area with each liquid reduces as a liquid level of liquid stored in a container is low. The AC signal is applied to the first electrode, and a detector circuit detects the AC signal inputted from the second electrode. The detector circuit outputs a voltage that continuously changes according to a residue of the liquid stored in the container. It is possible that a residue of the liquid is continuously detected, controlling deposition of a viscous material or the like.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a drawing indicating a configuration of a liquid residue detection device according to one embodiment of the present disclosure;

FIG. 2 is a drawing showing an example of a property of a depth of a washing liquid and detection voltage; and

FIG. 3 is a drawing illustrating a relationship of a depth of a washing liquid and an appearance magnitude of resistance between the first electrode and the second electrode.

### DETAILED DESCRIPTION

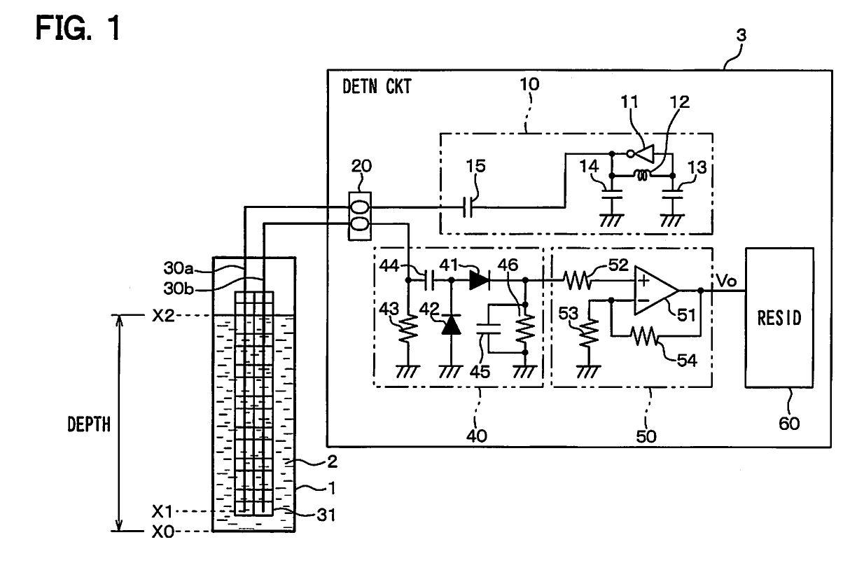

A liquid residue detection device according to one embodiment of the present disclosure is described in FIG. 1. The liquid residue detection device is used for a window washing device to wash a window of a vehicle. The liquid residue detection device includes a tank (corresponding to a container) 1 storing a washing liquid, a first electrode 30a and a second electrode 30b placed to contact the washing liquid 2 stored in the tank 1, and a detection circuit 3. Incidentally, the washing liquid 2 is a conductive liquid including methyl alcohol, a surfactant, or the like. Incidentally, the washing liquid 2 may correspond to a liquid in the present disclosure.

In addition, the electrodes 30a, 30b are provided by stainless lines. In addition, the electrodes 30a, 30b are placed in the tank 1, so that each tip of the electrodes 30a, 30b extends to near the bottom of the tank 1. As a position of a liquid level of the washing liquid 2 stored in the tank 1 becomes low, an area contacting between each of the electrodes 30a, 30b and the washing liquid 2 reduces.

An electrode fixing portion 31 is provided to prevent a short circuit between the electrode 30a and the electrode 30b, and includes a mesh shaped member made of resin. Therefore, the electrode fixing portion 31 may also referred to as an insulation mesh shaped member in the present disclosure. The electrode fixing portion 31 includes a hole for inserting the electrode 30a, and another hole (neither is illustrated) for inserting the electrode 30b.

The electrode 30a is inserted into the hole for inserting the electrode 30a, the electrode 30b is inserted into the hole for inserting the electrode 30b, and the electrode 30a and the electrode 30b are fixed to the electrode fixing portion 31 so as not to directly become a short circuit.

The detection circuit 3 includes a AC signal generation portion 10 generating the AC signal, a connector 20 for connecting the first electrode 30a and the second electrode 30b, a detector circuit 40 detecting the AC signal inputted from the second electrode 30b, an amplifying portion 50 amplifying the AC signal detected by the detector circuit 40, and a residue specifying portion 60 for specifying a residue of the washing liquid 2.

An AC signal generation portion 10 includes an inverter 11, an inductance 12, and capacitors 13-15.

The inductance 12 is provided between an input terminal and an output terminal of the inverter 11. In addition, the input terminal of the inverter 11 is grounded through the capacitor 13, and the output terminal of the inverter 11 is grounded through the capacitor 14. In addition, the output terminal of the inverter 11 is connected to the first electrode 30a through one of terminals of the capacitor 15 and the connector 20.

When a voltage of the input terminal of the inverter 11 is a low level, a voltage of the output terminal of the inverter 11 becomes high level. In this case, the voltage of the input terminal of the inverter 11 rises gradually by the inductance 12 and the capacitor 13. When the voltage of the input terminal of the inverter 11 rises to a threshold voltage, the voltage of the output terminal of the inverter 11 becomes low level. In this case, when the voltage of the input terminal of the inverter 11 reduces gradually by the inductance 12 and the capacitor 13, and the voltage of the input terminal of inverter 11 falls to a threshold voltage, the voltage of the output terminal of the inverter 11 becomes high level. These operations are performed repeatedly, and the AC signal, which repeats the high level and the low level, is outputted from the output terminal of the inverter 11.

The detector circuit 40 includes diodes 41, 42, resistances 43, 46, and capacitors 44, 45. When an AC signal is applied to the first electrode 30a, and a conductive state between the first electrode 30a and the second electrode 30b is provided through the washing liquid 2 stored in the tank 1, the AC signal is inputted into the detector circuit 40 from the first electrode 30a through the second electrode 30b. The detector circuit 40 detects the AC signal inputted from the second electrode 30b, and outputs the voltage, which changes continuously according to the residue of the washing liquid 2 stored in the tank 1.

The amplifying portion 50 includes an operational amplifier 51 and resistances 52-54. Amplifying portion 50 operates as a non-inverting amplifier. Therefore, the amplifying portion 50 amplifies the voltage that is outputted from the detector circuit 40 with an amplification factor that is defined in advance. The amplifying portion 50 outputs an amplified detection voltage Vo.

The residue specifying portion 60 includes a computer provided with an A/D converter, a CPU, a memory, an I/O (neither is illustrated), or the like. The residue specifying portion 60 converts the detection voltage Vo amplified with the amplifying portion 50 into a digital signal, and specifies a residue of the washing liquid 2 stored in the tank 1 based on the voltage value converted into the digital signal.

In the above configuration, when the AC signal generation portion 10 applies the AC signal to the first electrode 30a, and the first electrode 30a and the second electrode 30b are in a conductive state through the washing liquid 2 stored in the tank 1, the AC signal is inputted into the detector circuit 40 from the first electrode 30a through the second electrode 30b. The detector circuit 40 performs half-wave rectification of the AC signal. The amplifying portion 50 amplifies a signal provided by the detector circuit 40 in the half-wave rectification. The residue specifying portion 60 receives the signal amplified by the amplifying portion 50, and specifies the residue of the washing liquid 2.

Incidentally, when the washing liquid 2 stored in the tank 1 decreases, and the first electrode 30a and the second electrode 30b are in a non-conductive state, the AC signal is not inputted into the detector circuit 40, and the detection voltage Vo, which is outputted from the amplifying portion 50, becomes less than the threshold defined in advance. The residue specifying portion 60 outputs an alarm signal representing that there are very few residual quantities of the washing liquid 2, when detection voltage Vo outputted from the amplifying portion 50 is less that the threshold.

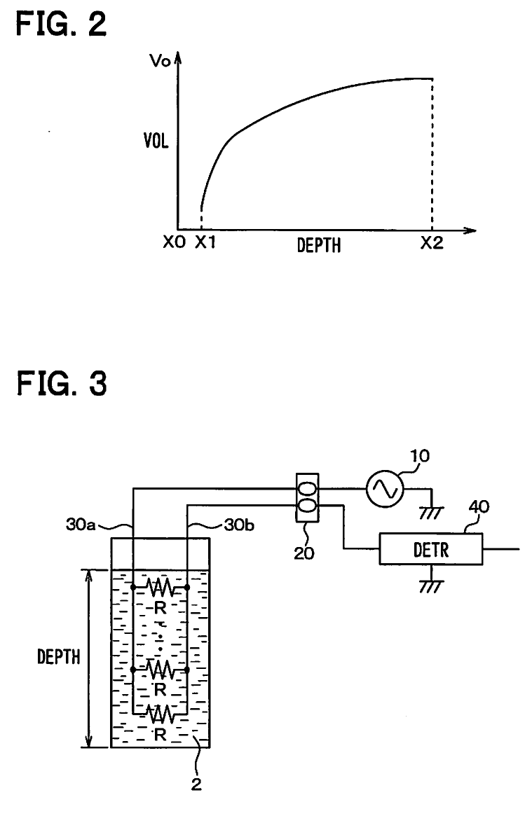

In the liquid residue detection device, as described in FIG. 2, as the depth of the washing liquid 2 becomes deep, the detection voltage Vo outputted from the amplifying portion 50 increases. In addition, when there are few residual quantities of the washing liquid 2, a variation per depth unit of the detection voltage Vo outputted from the amplifying portion 50 increases as compared with a case where there are much residual quantities of the washing liquid 2.

It is supposed that, as described in FIG. 3, as the depth of the washing liquid 2 becomes deep, the appearance magnitude of resistance (a combined resistance) between the first electrode 30a and the second electrode 30b becomes small.

In the liquid residue detection device, the detection voltage Vo outputted from the amplifying portion 50 increases as the depth of the washing liquid 2 becomes deep as described in FIG. 2. The liquid residue detection device specifies continuously the residue of the washing liquid 2 stored in the tank 1. Specifically, the memory stores a function (for example, an approximate expression) representing a property described in FIG. 2, and the CPU of the residue specifying portion 60 uses the function stored in the memory, specifies almost continuously the residue of the washing liquid 2 stored in the tank 1 from the detection voltage Vo, and outputs a signal representing the residue of the washing liquid 2.

In the present embodiment, the first electrode 30a and the second electrode 30b are fixed to the electrode fixing portion 31 provided using the mesh shaped member. When fluctuation occurs on the liquid level of the washing liquid 2 by an acceleration and deceleration of the vehicle, an oscillation in travelling, or the like, it is prevented that the fluctuation causes the detection value of the residue of the washing liquid 2 to be changed with a short cycle.

When the fluctuation of the liquid level of washing liquid 2 temporarily occurs by an acceleration and deceleration of the vehicle, an oscillation in travelling, or the like, the washing liquid 2 adheres to a high position of the electrode fixing portion 31 as compared with a case before the fluctuation occurs. This state keeps until a time is passed and the washing liquid 2, which has adhered to the high position of the electrode fixing portion 31 as compared with the case before the fluctuation occurs, is disappeared by vaporization or the like.

As described above, by fixing the first electrode 30a and the second electrode 30b into the electrode fixing portion 31 provided using the mesh shaped member, it is prevented that the detection value of the residue of the washing liquid 2 is changed with a short cycle by the fluctuation of the liquid level of the washing liquid 2. The fluctuation is occurred by the acceleration and deceleration of the vehicle and the oscillation in travelling.

According to the above configuration, the first electrode 30a and the second electrode 30b are placed so that the area where each of the electrodes 30a, 30b contacts with the washing liquid 2 decreases when the position of the liquid level of the washing liquid 2 stored in the tank 1 becomes low. The AC signal is applied to the first electrode 30a, and the detector circuit 40 detects the AC signal inputted from the second electrode 30b. The detector circuit 40 outputs voltage. The outputted voltage continuously changes according the residue of the washing liquid 2 stored in the tank 1. It is possible to detect the residue of the washing liquid 2 continuously.

In a configuration applying a DC signal between multiple electrodes and detecting the residue of the washing liquid, a relatively large amount of a viscous material is deposited due to electrolysis and the viscous material adheres to the electrodes. In the configuration of the liquid residue detection device in which the AC signal is applied to the first electrode 30a and the detector circuit 40 detects the AC signal inputted from the second electrode 30b, it is possible that a progress of an electrolysis is prevented and a deposition is prevented.

Since the insulation mesh shaped member 31 is provided between the first electrode 30a and the second electrode 30b, it is possible to prevent the detection value of the residue of the washing liquid 2 from changing with a short cycle due to the fluctuation of the liquid level of the washing liquid 2 by the acceleration and deceleration of a vehicle and the oscillation in travelling.

Incidentally, the present disclosure is not limited to the above mentioned embodiment, and it is possible to be performed in various modes based on a scope of the present disclosure.

For example, although the configuration detecting the residue of the washing liquid 2 used in the window washing device washing the window of the vehicle is described, for example, a liquid residue detection device may detect conductive various liquid such as a tap water, a potable water, or the like.

According to one aspect of the present disclosure, a liquid residue detection device detecting a residue of a liquid is provided. The liquid residue detection device includes (i) a first electrode and a second electrode placed into the container so that areas that each of the first electrode and the second electrode contacts with the liquid decrease as a liquid level of the liquid stored in the container is low, (ii) an AC signal generation portion generating an AC signal applied to the first electrode, and (iii) a detector circuit detecting the AC signal inputted from the second electrode and outputting voltage that changes continuously according to a residue of the liquid stored in the container.

According to the liquid residue detection device, a first electrode and a second electrode are placed so that a contact area with each liquid reduces as a liquid level of liquid stored in a container is low. The AC signal is applied to the first electrode, and a detector circuit detects the AC signal inputted from the second electrode. The detector circuit outputs a voltage that continuously changes according to a residue of the liquid stored in the container. Therefore, It is possible that a residue of the liquid is continuously detected, controlling deposition of a viscous material or the like.

While the present disclosure has been described with reference to examples thereof, it is to be understood that the disclosure is not limited to the examples and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A liquid residue detection device detecting a residue of a liquid stored in a container, the liquid residue detection device comprising:
a first electrode and a second electrode placed into the container so that areas that each of the first electrode and the second electrode contacts with the liquid decrease as a liquid level of the liquid stored in the container is low;
an AC signal generation portion generating an AC signal applied to the first electrode; and
a detector circuit detecting the AC signal inputted from the second electrode, and outputting voltage that changes continuously according to the residue of the liquid stored in the container.

2. The liquid residue detection device according to claim 1, further comprising
an insulation mesh shaped, member provided between the first electrode and the second electrode.

3. The liquid residue detection device according to claim 1, further comprising
an amplifying portion amplifying the AC signal detected by the detector circuit to provide an amplified signal, and
a residue specifying portion receiving the amplified signal from the amplifying portion and specifying the residue of the liquid stored in the container based on a voltage value of the amplified signal.

4. The liquid residue detection device according to claim 1, further comprising
an electrode fixing portion provided between the first electrode and the second electrode, wherein
the electrode fixing portion has an insulation property, and
the electrode fixing portion prevents the first electrode and the second electrode from contacting each other.
